(19) United States
(12) Patent Application Publication
(10) Pub. No.: US 2006/0086429 A1
(43) Pub. Date: Apr. 27, 2006

(54) Cold-rolled steel strip with silicon content of at least 3.2 wt % and used for electromagnetic purposes

(76) Inventors: Yvan Houbaert, Laarne (BE); Carl-Dieter Wupperman, Krefeld (DE); Olaf Fischer, Bochum (DE); Jurgen Schneider, Bochum (DE)

Correspondence Address: PROSKAUER ROSE LLP;PATENT DEPARTMENT, 1585 BROADWAY, NEW YORK, NY, 10036-8299, US

(21) Appl. No.: 10/513,767

(22) PCT Filed: May 2, 2003
(86) PCT No.: PCT/EP03/04588

§ 371 Date: Aug. 24, 2005

(30) Foreign Application Priority Data
May 7, 2002 (DE) 102 20 282.6

(51) Int. Cl. H01F 1/04

(52) U.S. Cl. 148/111

(57) ABSTRACT

The present invention relates to a cold-rolled steel strip or sheet in thicknesses of ≦0.70 mm for electromagnetic applications, consisting of a steel containing (in % by weight) C: <0.01%, Si: 3.2-7%, Al: <2%, Mn: ≦1%, the remainder being iron and usual impurities, which after smelting has been cast to form a base material, such as a slab, a thin slab, or a thin strip, which has then been heated through to temperature T_{R}>1000° C. and has been final hot-rolled at a hot-rolling final temperature T_{F}>800° C. to form a hot strip, which has then been cooled, starting from a temperature T_{C} of the hot strip amounting to at least 750° C. but less than 850° C., at a cooling speed ΔT/Δt of at least 400° C./min. to a temperature of less than 300° C., subjected after cooling to a surface treatment such as mechanical descaling and/or pickling, after the surface treatment has been cold-rolled at a temperature amounting to maximum 500° C., and has finally been final-annealed.

The invention relates to a cold-rolled steel strip or sheet in thicknesses of ≦0.70 mm for electromagnetic applications with Si-contents of at least 3.2% by weight and Al-contents of less than 2% by weight, as well as a method for the manufacture thereof. Such cold strips or sheets produced on the basis of high silicon-content FeSi steels are usually used as non-grain-oriented electric sheets.

The term “non-grain-oriented electric sheet” is understood in this case to mean products which fall under DIN EN 10106 (“final annealed electric sheet”) and DIN EN 10165 (“non-final annealed electric sheet”). In addition to this, stronger anisotropic types are also included, provided that they are not deemed to be grain-oriented electric sheets. Accordingly, hereinafter the terms “steel strip for electromagnetic purposes” and “steel sheet for electromagnetic purposes”, as well as “electric strip” and “electric sheet” are used synonymously.

Conventionally, FeSi steels are used for the manufacture of non-grain-oriented electric sheets, of which the Si content is a maximum of 3.5% by weight. FeSi steel alloys which have such limited Si contents allow for problem-free production by conventional means of manufacture. In particular, by restricting the Si content to ≦3.0% by weight it can be ensured that with conventional techniques the sheet which is obtained will be free of cracks after cold rolling.

In the course of conventional production, after the smelting of the steel alloy, the melt is cast to form a slab or thin slab. This base material is then rolled to form a hot strip, in direct application without reheating or after cooling and then reheating, in a hot rolling process comprising descaling, rough rolling, and finish hot rolling, carried out in a hot staggered rolling process, as a rule with multiple rolling stands. The hot strip is then subjected to surface treatment, carried out as a rule as pickling, which can be combined with annealing. If required, hot annealing is also carried out before the hot strip is cold-rolled to form cold strip. The strip is final-annealed or subjected to annealing with subsequent deformation.

As early as with Si contents of more than 3% by weight, the first difficulties become apparent with cold rolling in the form of high rolling forces and increasing propensity to crack. For example, cracks regularly appear when cold-rolling hot strips produced from FeSi alloys with FeSi contents of more than 3.5% by weight, which exclude the production of a high-quality electrical sheet product with thicknesses≦0.75 mm by conventional production means.

Offsetting the difficulties with manufacture is the fact that the increase in the Si content leads to an increase in the electrical resistance, and therefore to a reduction in the magnetic losses when in use. Electric sheets made from FeSi alloys with Si contents in the range from 3.5% by weight to 7.0% by weight are therefore of particular interest for a series of applications, in particular for small and very small machines used in the audio, video, data-processing, and medical technology sectors, as well as for drive units and magnetic cores which operate at higher frequencies. These materials, with very high silicon contents, have a high degree of saturation magnetisation in relation to other low-magnetic materials, such as amorphous alloys based on Fe, FeNi, or FeCo, nanocrystalline low-magnetic materials or low-magnetic ferrites. This higher saturation magnetisation is combined with higher values of electrical resistance in comparison with conventional electrotechnical steels, and therefore lower magnetic losses, as a result of which application at higher frequencies is rendered possible.

FeSi materials with Si contents of close to 6.5% by weight are available on the market. The manufacture of these products is effected by way of the chemical depositing of a very highly siliconized FeSi layer on a conventional electric strip and subsequent diffusion annealing.

In this way it is indeed possible, with conventional production of sheets having high silicon contents, for difficulties to be avoided. However, additional operational steps are required for this, which render manufacture complicated and expensive.

There are numerous studies in the scientific literature in which the forming behaviour of FeSi alloys with Si contents of more than 3.2% by weight has been examined, and the possibilities of the manufacture of a steel of this nature by conventional metallurgical means have been considered. Thus, for example, G. Schlatte, W. Pietsch, in the “Zeitschrift für Metallkunde” (Journal of Metal Science), Edition 66 (1975), Volume 11, pages 661 et seq., and W. Pepperhoff, W. Pietsch, in “Archiv Eisenhüttenwesen” (Metallurgical Archive) 47 (1976), No. 11, pages 685 et seq., mention the fact that a steel with up to approx. 6% by weight silicon can still be shaped or formed at temperatures of around 400° C. to 300° C. (critical temperature: 300° C.). Below a critical temperature, which depends on the Si content, a brittle behaviour sets in, and, as a result of this, a cold brittleness, which does not allow for any cold forming. Above the critical temperature, by contrast, forming is possible for FeSi alloys with more than 4% by weight of silicon, provided that, in addition, the alloy being processed in each case is cooled from temperatures below 700° C. to a temperature of below 400° C.

The restriction on formability to a temperature range above the critical temperature, identified in the technical articles referred to, also restricts the possibilities of the manufacture of very highly siliconized electric steel products by conventional manufacturing means.

It has been established by G. Rassmann, P. Klemm, in “Neue Hütte” (New Metallurgy), Volume 7, 8th Annual Series, 1963, pages 403 et seq., that for alloys with 5 and 6% by weight Si cold rolling at 220° C. or 350° C. can be achieved, with a total forming or shaping of up to some 40% and further rolling at room temperature. With this kind of cold rolling, carried out in two stages at different temperatures, however, the previous history of the material up to the cold rolling stage is not of any significance.

It has been shown in practice, however, as the studies by G. Schlatte and W. Pietsch referred to heretofore confirm, that such cold rolling cannot in reality be carried out without further ado for hot strip manufactured simply in any fashion; in other words, the manufacture of the hot strip has a considerable influence on the possibility of working a hot strip with very high silicon content to form cold strip.

In addition to the prior art referred to heretofore, the principle is known from EP 0 229 846 B1 of adjusting the degree of total shaping or forming achieved with hot rolling as a function of the grain size, before final rolling (finish hot-rolling). This process suffers from the disadvantage, however, that the grain size before final rolling is dependent on the conditions of the reheating and pre-rolling, as well as on the individual chemical composition. As a result, the grain sizes present in the pre-rolled steel primary product before entering the finish hot-rolling stage is not unambiguously specified. In addition to this, the measurement of grain size in a manufacturing process which in practice takes place continuously cannot be carried out with a degree of effort and expenditure which is acceptable in terms of technology and cost.

In EP 0 377 734 B1 a method has been described for FeSi alloys with which, after the reheating of the slabs, forming takes place at temperatures of not less than 600° C., and thereafter direct application takes place for further hot rolling or repeat heating to temperatures of not less than 400° C., with subsequent hot rolling. This is followed by cold rolling to final thickness. These process parameters are not specific for alloys with high silicon content. In practice it has been shown that, with the use of the process stages known from EP 0 377 734 B1 for FeSi alloys with very high silicon content, of the type processed in accordance with the invention, it is not possible to achieve satisfactory working results.

According to EP 0 467 265 A2, a very highly-siliconized FeSi steel can be cold-rolled, in that the cold-rolling takes place at sheet temperatures in the range from 120° C. to 350° C. However, it is not indicated in this situation as to how the hot strip which can be processed in this way must be manufactured. In the practical application of this known method, the problem therefore arises that, as the technical articles referred to heretofore and own investigations conducted by the Applicant's attest, the processing of very highly-siliconized electric steel is simply not independent of the parameters maintained during the hot strip processing. Practical experiments have therefore revealed that, with a conventional manufacturing method of hot strip with Si contents above 3.5% by weight and subsequent cold-rolling under the conditions given in EP 0 467 265 A2, crack formation regularly occurs even at the first cold-rolling pass.

Taking the prior art outlined heretofore as a starting point, the object of the invention lies in providing a cold-rolled steel sheet or strip, which it is practical to manufacture and suitable for electromagnetic applications, with thicknesses of maximum 0.70 mm and an Si content of 3.5% by weight and more, as well as describing a method with which a product of this type can be economically manufactured.

With regard to the product, this object is achieved by a cold-rolled steel strip or sheet in thicknesses of ≦0.70 mm for electromagnetic applications, manufactured from a steel which contains (in % by weight) : C: <0.01%, Si: 3.2-7%; Al: <2%; Mn: ≦1%, with the remainder iron and the usual impurities, and which, after smelting, has been cast to form a base material, such as a slab, a thin slab, or a thin strip, which was then heated through to a temperature T_{R}>1000° C. and has been hot finish-rolled at a hot strip final temperature T_{F} of >800° C. to form a hot strip, which was then cooled, starting from a temperature T_{C} of the hot strip of at least 750° C. but less than 850° C., at a cooling speed ΔT/Δt amounting to at least 400° C./min., to a temperature amounting to less than 300° C., subjected after cooling to a surface treatment such as mechanical descaling and/or pickling, has been cold-rolled after the surface treatment at a temperature T_{CR} amounting to a maximum of 500° C., and has then been final-annealed.

With regard to the method, the solution in accordance with the invention of the object described lies in running through the following steps during the manufacture of a cold-rolled steel strip or sheet for electromagnetic applications:
Smelting of a steel containing (in % by weight): C: <0.01%, Si: 3.2-7%; Al: <2%; Mn: ≦1%, with the remainder iron and the usual impurities,
Casting of the steel to form a base material, such as a slab, a thin slab, or a thin strip,
Heating the base material through to a temperature T_{R}>1000° C.,
Finish-rolling of the heated-through base material at a hot-rolling final temperature T_{F} of >800° C. to form a hot strip,
Cooling of the hot strip following the finish-rolling, starting from a temperature T_{C} of the hot strip of at least 750° C. but less than 850° C., at a cooling speed ΔT/Δt amounting to at least 400° C./min., to a temperature amounting to less than 300° C.,
Surface treatment of the cooled hot strip,
Cold-rolling of the surface-treated hot strip at a temperature T_{CR} amounting to a maximum of 500° C., and
Final annealing of the cold-rolled steel strip or sheet obtained.

The invention is based on the understanding that a high-quality, in particular crack-free, cold strip can be manufactured, starting from a conventionally-composed steel alloy containing very high quantities of silicon of 3.2% to 7% by weight, as well as Al contents of up to 2% by weight, while maintaining the working steps applied in conventional cold strip production, if
The reheating temperature,
The hot-rolling final temperature,
The rapid cooling of the hot strip after the end of finish-rolling, starting from a temperature lying in a specific temperature range, and
The temperature of the strip at cold-rolling are matched to one another in the manner specified by the invention.

Surprisingly, it has been shown that, only by maintaining the combination in accordance with the invention of the parameters concerned can an excessive brittleness of the processed material be avoided, and the hot strip possesses a ductility sufficient for cold rolling in the due and proper manner, which is required for the manufacture of crack-free electric sheet with the desired final thickness of maximum 0.70 mm, and preferably maximum 0.35 mm.

In this situation, each of the parameters concerned is accorded an equal significance. Thus it has been determined that, in such cases in which the temperature range indicated for the start of cooling has been exceeded or undercut beyond a certain tolerance range, it is not possible to obtain a crack-free product.

In cases in which the hot-rolled final temperature amounts to more than 800° C. but less than 850° C., the cooling of the hot strip can be carried out immediately following the hot rolling. On the other hand, it is necessary to wait for the start of rapid cooling until the temperature of the hot strip has fallen into the range specified according to the invention, within which the rapid cooling should set in.

Naturally, the hot strip cooled in accordance with the invention can be wound into a coil at a suitable moment of the manufacturing sequence before being conducted onwards for further processing to form a cold strip.

It is naturally also possible to restrict the manufacturing sequence in accordance with the invention to plates. With regard to the transition from hot-strip production to the manufacture of the cold strip, particular significance is attached in this situation to the speed with which the rapid cooling of the hot strip is carried out following the hot rolling. If the further processing of the hot strip to cold strip is effected in a period of time within which cold brittleness has not yet occurred even in the area of the lower limit of the cooling speed which is to be maintained in accordance with the invention, it is still possible to manufacture a crack-free cold-rolled steel product even at relatively low cooling speeds. However, if a longer period elapses between the hot strip manufacture and the cold-rolling, such as many days or weeks, then a crack-free steel strip or sheet for electromagnetic purposes, manufactured in the manner in accordance with the invention, can still be reliably manufactured in that the cooling speed ΔT/Δt amounts to at least 2000° C./min. As a result of such a high cooling speed, the brittling effects which are to be anticipated with an extended period of storage of the hot strip, and with cooling effected slowly, can be reliably avoided.

Preferably, re-heating of the base material takes place at temperatures in the range from 1000° C. to 1190° C., in order reliably to avoid the formation of feyalite.

Particularly good electromagnetic properties of the cold-rolled electric sheet obtained are acquired if the base material, possibly pre-rolled, is finish-rolled in a maximum of seven passes with a total deformation of more than 90% to a hot-strip final thickness of maximum 1.5 mm. The same purpose is served if the degree of-deformation at the cold-rolling is greater than 60% but less than 82%.

A further important feature of the invention consists of the fact that, during the cold rolling, the upper limit specified by the invention of the temperature of the processed strip is maintained within the framework of the tolerance which is unavoidably incurred due to the manufacturing process. In principle, therefore, it is of advantage if the hot strip has room temperature at the start of the cold rolling. In this situation, the development of heat which is unavoidable as a result of the onset of deformation energy during the cold rolling should preferably be conducted off in such a way that temperatures of ≦200° C. will not be exceeded. Nevertheless, taking into consideration the research results referred to in the preamble, in the event of the cold rolling being carried out at elevated temperatures, these should lie in the range from 200° C. to 500° C. The time provided for the preheating of the hot strip before hot rolling should in this situation be restricted to less than 20 minutes, in order to avoid microstructure changes which will otherwise occur, and which will incur brittling manifestations.

The invention is suitable for the production of electric steel sheets in the lower range of very highly siliconized steels, containing 4.0-5.0% by weight Si, for the production of electric steel sheets falling in the middle range of highly siliconized steels, containing more than 5.0% by weight Si, as well as of electric steel sheets falling in the upper range of highly siliconized steels, containing 6.0-6.8% by weight Si. In this situation, in particular with the alloys having the higher Si contents, the content of Al can be restricted to the range of the unavoidable impurities.

The invention is explained in greater detail hereinafter on the basis of embodiments.

To demonstrate the effect of the invention, an HiSi steel and an LoSi steel were smelted and cast to form slabs. The alloys of the HiSi and LoSi steels are shown in Table 1.

TABLE 1

| Alloy | Si | Al | C | Mn | S | Remainder |
|---|---|---|---|---|---|---|
| LoSi | 4.2 | 0.003 | 0.009 | 0.047 | 0.003 | Fe, other impurities |
| HiSi | 6.3 | 0.002 | 0.006 | 0.088 | 0.002 | Fe, other impurities |

Data in % by weight

The slabs are reheated to a reheating temperature T_{R}, rough rolled, and then finally hot-rolled in a hot-rolling stage comprising seven stands of rolls, at a hot-rolling final temperature T_{F} to form a hot strip with a thickness WB_{D}.

After leaving the hot-rolling stage, the hot strip was cooled at a cooling speed ΔT/Δt amounting to at least 400° C./min., as soon as its temperature T_{C} lay within the range from 750° C. to 850° C. The hot strip cooled in this way was then subjected to a mechanical pre-treatment of its surfaces and then pickled.

In order to demonstrate the influence of a heating of the hot strip before the cold rolling, a part of the hot strips produced in the manner described heretofore were heated in each case to a temperature T_{CR} in each case within a time t_{CR}.

During the cold-rolling itself, total deformation degrees Δ_{KW} were achieved.

Table 2 shows process parameters maintained in the course of manufacture for six cold strips E1 to E6, produced in accordance with the invention.

TABLE 2

| | E1 | E2 | E3 | E4 | E5 | E6 |
|---|---|---|---|---|---|---|
| Alloy | HiSi | HiSi | HiSi | LoSi | LoSi | LoSi |
| TR [° C.] | 1150 | 1150 | 1150 | 1150 | 1150 | 1150 |
| TF [° C.] | ≈940 | ≈940 | ≈940 | ≈950 | ≈950 | ≈950 |
| WBD [mm] | 1.8 | 1.8 | 1.8 | 1.7 | 1.7 | 1.7 |
| TC [° C.] | ≈780 | ≈780 | ≈780 | ≈820 | ≈820 | ≈820 |
| ΔT/Δt | ≈2100 | ≈2100 | ≈2100 | ≈2100 | ≈2100 | ≈2100 |
| [° C./min] | | | | | | |
| TCR [° C.] | RT *) | 300 | 500 | RT *) | 300 | 500 |
| tCR [min] | — | ≈18 | ≈18 | | ≈14 | ≈18 |
| ΔKW [%] | 67 | 68 | 68 | 72 | 72 | 72 |
| Crack | NO | NO | NO | NO | NO | NO |
| formation | | | | | | |

*) RT = Room temperature

These examples attest to the fact that, despite the high silicon contents of both processed steel alloys, HiSi and LoSi crack-free electric steel sheets can be manufactured as long as the re-heating temperature, the hot-rolling final temperature, the temperature at which cooling begins, the cooling speed, and the temperature at the hot-rolling remain within the framework specified in the invention.

In order to verify this further, three cold strips V1 to V3 were manufactured from the alloy HiSi, and a cold strip V4 from the alloy LoSi, with the application of the process steps used during the manufacture of the samples E1 to E6 in accordance with the invention, but with process parameters lying outside the specifications of the invention. The parameters concerned are entered in Table 3 for the cold strips V1 to V4, not in accordance with the invention, which were manufactured for the purpose of comparison.

TABLE 3

| | V1 | V2 | V3 | V4 |
|---|---|---|---|---|
| Alloy | HiSi | HiSi | HiSi | LoSi |
| TR [° C.] | 1150 | 1150 | 1250 | 1250 |
| TF [° C.] | ≈1000 | ≈730 | ≈850 | ≈800 |
| WBD [mm] | 2.1 | 1.4 | 1.65 | 1.85 |
| TC [° C.] | 1000 | ≈650 | ≈800 | ≈800 |
| ΔT/Δt [° C./min] | ≈2100 | ≈2100 | ≈1 | ≈1 |
| TCR [° C.] | RT *) | RT *) | RT *) | RT *) |
| tCR [min] | — | — | — | — |
| ΔKW [%] | **) | **) | **) | **) |
| Crack formation | YES | YES | YES | YES |

*) RT = Room temperature
**) Cold rolling breaks due to crack formation at the first pass

It has been shown that a deviation even in only one process parameter leads to the situation in which no more crack-free cold strip can be produced. For example, with the comparison sample V1, the excessively high temperature T_{C}, from which the rapid cooling took place as a starting point, already led to crack formation, with the other parameters lying within the scope of the invention, essentially concurring with the sample E1 according to the invention. The same effect was incurred with the excessively low temperature T_{C} with the comparison sample V2 and the excessively low cooling speed ΔT/Δt with the comparison examples V3, V4.

1. Method for the manufacture of a cold-rolled steel strip or sheet for electromagnetic applications, during which the following steps are run through:
smelting of a steel containing (in % by weight):
C: <0.01%
Si: 3.2-7%
Al: <2%
Mn: ≦1%,
the remainder being iron and usual impurities,
casting of the steel to form a base material, such as slabs, thin slabs, or thin strip,
heating through the base material to a temperature T_{R} of >1000° C.
heating the base material through at a hot-rolling final temperature T_{F} of >800° C. to form a hot strip,
cooling the hot strip following the finish hot-rolling, starting from a temperature T_{C} of 750° C. as a minimum but less than 850° C. of the hot strip, at a cooling speed ΔT/Δt of at least 400° C./min, to a temperature of less than 300° C.,
surface treatment of the cooled hot strip,
cold-rolling of the surface-treated hot strip at a temperature T_{CR} amounting to a maximum of 500° C., and
final annealing of the cold-rolled steel strip or sheet obtained.

2. Method according to claim 1, wherein the cooling speed ΔT/Δt is ≧2000° C./min.

3. Method according to claim 1, wherein the reheating of the base material takes place at temperatures in the range from 1000° C. to 1190° C.

4. Method according to claim 1 wherein the base material is finish hot-rolled in a maximum of seven passes at a total deformation rate of more than 90% to a thickness of the hot strip of maximum 1.5 mm.

5. Method according to claim 1 wherein the degree of deformation during cold-rolling is greater than 60% but less than 82%.

6. Method according claim 1 to any one of the foregoing wherein the cold-rolled steel strip or sheet obtained has a thickness of maximum 0.35 mm.

7. Method according to claim 1 wherein the hot strip has room temperature at the beginning of the cold-rolling.

8. Method according to claim 1 wherein the cold-rolling is carried out at temperatures of ≦200° C.

9. Method according to claim 1 wherein the hot strip is heated before the hot-rolling, within a period of less than 20 minutes, to a temperature from 200° C. to 500° C., and is cold-rolled at temperatures lying within this range.

10. Method according to claim 1 wherein the final annealing takes place in a decarburizing atmosphere.

11. Method according to claim 1 wherein the final annealing takes place in a non-decarburizing atmosphere.

12. Method according to claim 1 wherein the steel contains 4.0-5.0 by weight Si.

13. Method according to claim 1 wherein the steel contains >5.0-6.8 by weight Si.

14. Method according to claim 1 wherein the steel contains 6.0-6.8 by weight Si.

15. Method according to claim 1 wherein the content of Al is restricted to the range of unavoidable impurities.

16. Method according to claim 1 wherein the surface treatment comprises a mechanical descaling and/or pickling.
